(19) United States
(12) Patent Application Publication
(10) Pub. No.: US 2021/0200050 A1
(43) Pub. Date: Jul. 1, 2021

(54) ELECTROCHROMIC ELEMENT

(71) Applicant: CANON KABUSHIKI KAISHA, Tokyo (JP)

(72) Inventors: Kazuho Saeki, Kanagawa (JP); Wataru Kubo, Tokyo (JP)

(21) Appl. No.: 17/198,707

(22) Filed: Mar. 11, 2021

Related U.S. Application Data
(63) Continuation of application No. PCT/JP2019/035714, filed on Sep. 11, 2019.

(30) Foreign Application Priority Data
Sep. 18, 2018 (JP) 2018-173513
Aug. 6, 2019 (JP) 2019-144644

(51) Int. Cl. G02F 1/1514; G02F 1/155; G02F 1/161; E06B 9/24; E06B 3/67

(52) U.S. Cl. CPC G02F 1/1514; G02F 1/155; G02F 1/161; G02F 1/1503; E06B 3/6722; G02F 2001/15145; G02F 2203/055; E06B 9/24

(57) ABSTRACT

According to one aspect of the present disclosure, an electrochromic element comprises: a first electrode; a second electrode; a peripheral seal disposed between the first electrode and the second electrode; and an electrochromic layer disposed in a space defined by the first electrode, the second electrode, and the peripheral seal, wherein the electrochromic layer includes an anodic electrochromic compound and a cathodic electrochromic compound, wherein the peripheral seal is an anode preferential peripheral seal that takes preference of oxidation reaction of anodic electrochromic compound near the peripheral seal, and wherein the anodic electrochromic compound in the electrochromic layer has a concentration greater than a concentration of the cathodic electrochromic compound.

### CROSS-REFERENCE TO RELATED APPLICATIONS

This application is a Continuation of International Patent Application No. PCT/JP2019/035714, filed Sep. 11, 2019, which claims the benefit of Japanese Patent Application No. 2018-173513, filed Sep. 18, 2018, and Japanese Patent Application No. 2019-144644, filed Aug. 6, 2019, all of which are hereby incorporated by reference herein in their entirety.

### BACKGROUND OF THE INVENTION

### Field of the Invention

The present invention relates to an electrochromic element, an optical filter using the electrochromic element, a lens unit, an imaging apparatus, and a window member.

### Description of the Related Art

A compound in which the optical properties (absorption wavelength, absorbance, etc.) of a substance are changed by an electrochemical redox reaction is referred to as an electrochromic (Hereinafter, “electrochromic” may be described as “EC”) compound. An EC element using an EC compound is applied to a display device, a variable reflectance mirror, a variable transmission window, etc. EC compounds are classified into two types, inorganic compounds and organic compounds. Among them, organic EC compounds have characteristics such that the absorption wavelength can be designed and changed with a relatively high degree of freedom, and that a high contrast of decolorization can be realized.

In a typical EC element having an organic EC compound, an EC layer containing the EC compound is disposed between a pair of electrodes, and a seal for holding the EC layer is disposed so as to surround the outer periphery of the EC layer. One typical type of EC element having this organic EC compound is a complementary EC element. In this complementary EC element, an anodic EC compound colored by oxidation and a cathodic EC compound colored by reduction are used as the EC compound. In a complementary EC element, an oxidation reaction of an anodic EC compound proceeds at an anode by applying a voltage between a pair of electrodes to generate a colored material, and a reduction reaction of a cathodic EC compound simultaneously proceeds at an opposite cathode to generate a colored material, and then the current flows. Therefore, the amount of the colorant of the anodic EC compound is basically equal to the amount of the colorant of the cathodic EC compound in the whole device.

The peripheral seal surrounding the outer periphery of the EC layer is used for the purpose of preventing leakage of the EC layer to the outside of the element and preventing penetration of a substance causing deterioration of the EC compound such as moisture and oxygen into the EC layer. From this viewpoint, the material constituting the peripheral seal preferably has low moisture permeability, low gas permeability, and low solubility in the solvent contained in the EC layer. Japanese Patent Application Laid-Open No. 2012-168554 discloses an EC element having excellent durability using an epoxy novolac resin composite as a material constituting a peripheral seal.

One of the important problems of the EC element is the responsiveness at the time of coloring and decolorizing. As a method for improving the responsiveness, it is known to increase the concentration of the EC compound.

In order to improve the response speed, the inventors of the present application have studied an EC element in which the concentration of an EC compound is increased, and have found that a color difference occurs at the time of coloring in a region near the peripheral seal and a region other than the peripheral seal in the EC layer, and that the color in the element becomes uneven. When such unevenness in colors (Hereinafter, this may be referred to as “uneven color”) occurs in the element, a problem arises because the color tone of light passing through the EC element changes. Accordingly, it is an object of the present invention to provide an EC element in which color unevenness caused by a peripheral seal is suppressed.

### SUMMARY OF THE INVENTION

According to one aspect of the present disclosure, an electrochromic element comprises: a first electrode; a second electrode; a peripheral seal disposed between the first electrode and the second electrode; and an electrochromic layer disposed in a space defined by the first electrode, the second electrode, and the peripheral seal, wherein the electrochromic layer includes an anodic electrochromic compound and a cathodic electrochromic compound, wherein the peripheral seal is an anode preferential peripheral seal that takes preference of oxidation reaction of anodic electrochromic compound near the peripheral seal, and wherein the anodic electrochromic compound in the electrochromic layer has a concentration greater than a concentration of the cathodic electrochromic compound.

According to another aspect of the present disclosure, an electrochromic element comprises: a first electrode; a second electrode; a peripheral seal disposed between the first electrode and the second electrode; and an electrochromic layer disposed in a space defined by the first electrode, the second electrode, and the peripheral seal, wherein the electrochromic layer includes an anodic electrochromic compound and a cathodic electrochromic compound, wherein the peripheral seal is a cathode preferential peripheral seal that takes preference of reduction reaction of cathodic electrochromic compound near the peripheral seal, and wherein the cathodic electrochromic compound in the electrochromic layer has a concentration greater than a concentration of the anodic electrochromic compound.

Further features of the present invention will become apparent from the following description of exemplary embodiments with reference to the attached drawings.

### BRIEF DESCRIPTION OF THE DRAWINGS

FIG. 1 is a cross-sectional view schematically showing an example of an EC element according to the present embodiment.

FIG. 2 is a diagram showing a typical distribution of color unevenness caused by the peripheral seal in the element surface.

FIG. 3 is a flowchart for determining a type of peripheral seal.

FIG. 4 is a diagram for explaining a method of defining a center portion of an element.

FIG. 5 is a diagram showing a difference between the spectrum shape of the coloring spectrum when the preferential coloring occurs and the spectrum shape of the coloring spectrum when the preferential coloring does not occur.

FIG. 6 is a diagram showing the correlation between the EC compound concentration and the degree of color unevenness caused by the peripheral seal.

FIG. 7 is a diagram schematically showing a mechanism of the occurrence of color unevenness caused by the peripheral seal.

FIG. 8A is a diagram for explaining a color unevenness measuring apparatus and an evaluation method.

FIG. 8B is another diagram for explaining a color unevenness measuring apparatus and an evaluation method.

FIG. 9A is a diagram schematically showing an example of an imaging apparatus and a lens unit.

FIG. 9B is another diagram schematically showing an example of an imaging apparatus and a lens unit.

FIG. 10A is a diagram schematically showing an example of a window member.

FIG. 10B is another diagram schematically showing an example of a window member.

FIG. 11 is a diagram showing the correlation between a concentration ratio A/C and the degree of color unevenness.

### DESCRIPTION OF THE EMBODIMENTS

<<EC Element (Electrochromic Element)>>

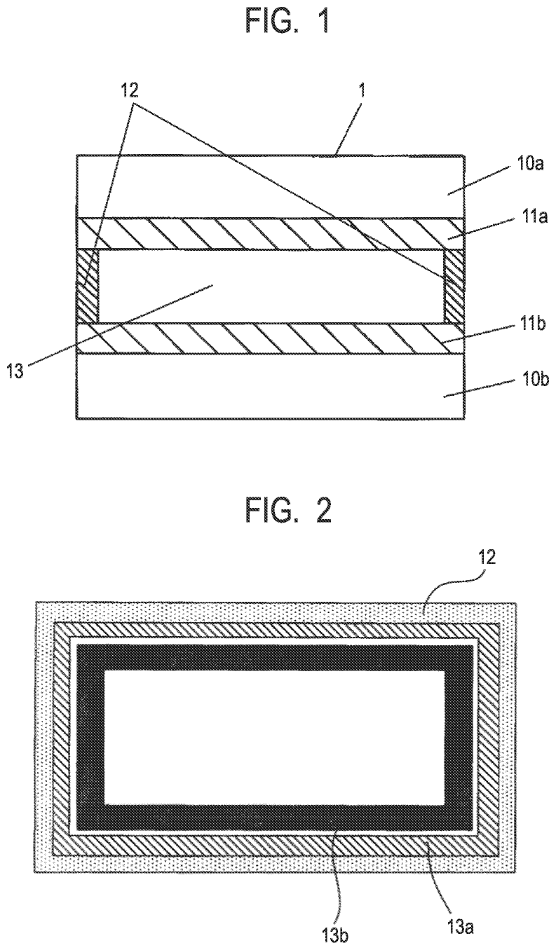

The EC element 1 according to the present embodiment is described with reference to FIG. 1. FIG. 1 is a cross-sectional view schematically showing an example of an EC element according to the present embodiment. Here, the cross section is a plane orthogonal to the element plane (electrode surface). The EC element 1 is a device for taking in light from the outside and changing the intensity of the emitted light in a predetermined wavelength region by passing the light taken in through the EC layer 13.

The EC element of this embodiment has a first electrode 11a and a second electrode 11b. The first electrode 11a and the second electrode 11b may be disposed on the first substrate 10a and the second substrate 10b, respectively. In the EC element of the present invention, a peripheral seal 12 is disposed between the first electrode 11a and the second electrode 11b. In a space defined by the first electrode 11a, the second electrode 11b, and the peripheral seal 12, an EC layer (electrochromic layer) 13 is disposed. The EC layer 13 has a solvent, an anodic EC compound (anodic electrochromic compound), and a cathodic EC compound (cathodic electrochromic compound). Components of the EC element of the present invention is described below.

<Electrodes 11a, 11b>

In the present invention, either one of the first electrode 11a and the second electrode 11b is preferably transparent. Here, “Transparent” means that the corresponding electrode transmits light, and the light transmittance is preferably from 50% to 100%. Since at least one of the first electrode 11a and the second electrode 11b is a transparent electrode, light can be efficiently taken in from the outside of the EC element, and the light can interact with the EC compound, so that the optical characteristics of the EC compound can be reflected on the emitted light. The term “light” as used herein refers to light in the wavelength region targeted by the EC element. For example, when an EC element is used as a filter of an imaging apparatus in a visible light region, light in a visible light region is an object, and when it is used as a filter of an imaging apparatus in an infrared region, light in an infrared region is an object.

The first electrode 11a and the second electrode 11b may be disposed on the first substrate 10a and the second substrate 10b, respectively. In the present invention, either one of the first substrate 10a and the second substrate 10b is preferably transparent. As a transparent substrate on which the electrodes 11a and 11b, glass or transparent resin can be used. As the glass, optical glass, quartz glass, white plate glass, blue plate glass, borosilicate glass, alkali-free glass, chemically reinforced glass or the like can be used. In particular, alkali-free glass can be used from the viewpoint of transparency and durability. As the transparent resin, polyethylene terephthalate, polyethylene naphthalate, polynorbornene, polysulfone, polyether sulfone, polyether ether ketone, polyphenylene sulfide, polycarbonate, polyimide, polymethyl methacrylate, and the like can be used. The non-transparent substrate on which the electrodes 11a and 11b are disposed includes an opaque resin. As the opaque resin, polypropylene, high-density polyethylene, polytetrafluoroethylene, polyacetal, polybutylene terephthalate and polyamide can be used.

As the transparent electrode, a transparent conductive oxide, a conductive layer such as dispersed carbon nanotubes, or a transparent electrode in which metal lines are partially arranged on a transparent substrate can be used.

As the transparent conductive oxide include tin doped indium oxide (ITO), zinc oxide, gallium doped zinc oxide (GZO), aluminum doped zinc oxide (AZO), tin oxide, antimony-doped tin oxide (ATO), fluorine doped tin oxide (FTO), niobium doped titanium oxide (TNO), and the like can be used, for example. Among these, FTO or ITO is preferable. When the electrode is formed of a transparent conductive oxide, the film thickness is preferably from 10 nm to 10,000 nm. In particular, a transparent conductive oxide layer having a film thickness with a range from 10 nm to 10,000 nm and being a layer of FTO or ITO is preferable, because the above configuration allows to achieve both high permeability and chemical stability. The transparent conductive oxide layer may have a structure in which sub-layers of the transparent conductive oxide are stacked. The above structure helps realize high conductivity and high transparency.

As the metal wire which can be disposed on the substrate, a wire of an electrochemically stable metal material such as Ag, Au, Pt, Ti, or the like is preferably used. A grid-like arrangement pattern is preferably used as the metal line arrangement pattern. The electrode having the metal wire is typically a planar electrode, but a curved electrode can be used if necessary.

Among the first electrode 11a and the second electrode 11b, the electrode other than the above-described transparent electrode is preferably selected according to the application of the EC element. For example, in the case where the EC element is a transmission type EC element, both the first electrode 11a and the second electrode 11b are preferably the above-described transparent electrodes. Further, when the electrodes are disposed on the substrate, both the first substrate 10a and the second substrate 10b are preferably transparent. On the other hand, when the EC element is a reflection type EC element, one of the first electrode 11a and the second electrode 11b is preferably the transparent electrode and the other electrode reflects incident light. Furthermore, when the electrodes are disposed on the substrate, at least the substrate on which the transparent electrodes are disposed is preferably transparent. On the other hand, by forming a reflection layer or a scattering layer between the electrodes, the degree of freedom of the optical characteristics of the electrodes other than the transparent electrode can be improved. For example, when a reflective layer or a scattering layer is introduced between the electrodes, an opaque electrode or a light-absorbing electrode can be used as the electrode behind the reflective layer or the scattering layer.

Regardless of the form of the EC element according to the present invention, the first electrode 11a and the second electrode 11b are preferably made of a material which stably exists in the operating environment of the element, and allow the oxidation-reduction reaction to rapidly progress in response to an external voltage application.

As for the arrangement of the first electrode 11a and the second electrode 11b, any arrangement generally known as an electrode arrangement of the EC element can be used. As a typical example, there is an arrangement system in which the first electrodes 11a and the second electrodes 11b arranged on the substrate face each other and a distance between the electrodes of about 1 μm or more but 500 μm or less is provided. When the electrodes are distantly disposed, an amount of the EC compound enough to effectively function as an EC element can be arranged. Thus, it is advantageous that the transmissivity at the time of coloring can be reduced. On the other hand, when the electrodes are closely disposed, it is advantageous that a fast response speed can be achieved.

<EC Layer 13>

The EC element of the present invention has an EC layer 13 containing an anodic EC compound and a cathodic EC compound, preferably further containing a solvent between the first electrode 11a and the second electrode 11b.

[Solvent]

The solvent constituting the EC layer 13 is selected according to the application in consideration of the solubility, vapor pressure, viscosity, potential window, etc. of the solute including the EC compound, but is preferably a solvent having polarity. More specifically, an ether compound, a nitrile compound, an alcohol compound, an organic polar solvent such as dimethyl sulfoxide, dimethoxyethane, sulfolane, dimethyl formamide, dimethyl acetamide, methyl pyrrolidinone and water can be used as a solvent. Among them, a solvent containing a cyclic ether such as propylene carbonate, ethylene carbonate, γ-butyrolactone, valerolactone, and dioxolane is preferably used from the viewpoint of solubility, boiling point, vapor pressure, viscosity, and potential window of the EC compound, and a solvent containing propylene carbonate is most preferably used.

[EC Compound]

In the present invention, the EC compound is a kind of redox substance, and is a substance of which light absorption characteristics change in an optical wavelength region targeted by an element due to an oxidation-reduction reaction. The redox substance is a compound which can repeatedly undergo redox reaction in a predetermined potential range. Here, the light absorption characteristic is typically a light absorption state and a light transmission state, and the EC compound is a material that typically switches between the light absorption state and the light transmission state. The EC compound used in the EC element of the present invention is preferably an organic compound. Organic EC compounds preferably used for the present invention are low molecular weight organic compounds having a molecular weight of 2000 or less.

In this specification, EC compounds are sometimes described as “anodic EC compound” and “cathodic EC compound”. Each of them is described in detail below.

(Anodic EC compound)

The anodic EC compound is a material of which light absorption characteristics are changed by an oxidation reaction in which electrons are usually removed from the EC compound on the anode in an optical wavelength region that the element is associated with. Typical examples include materials that change from a light transmitting state to a light absorbing state. In order to help image the change in the EC compound, the change from the light transmitting state to the light absorbing state, which is a typical example, is picked up and described in this specification. In the present specification, a molecule in a light-transmitting state is sometimes referred to as a “decolorized material” or a “decolorized substance”, and a molecule in a light-absorbing state is referred to as a “colored material” or a “colored substance”. In this case, the reductant of the anodic EC compound is in a light transmitting state in the light wavelength region as an object of the element, and is referred to as “decolorized material”. The oxidant of the anodic EC compound is in a light absorption state and is referred to as “colored material”.

Examples of the anodic EC compound include thiophene derivatives, amines having an aromatic ring (e.g., phenazine derivatives, triallylamine derivatives), pyrrole derivatives, thiazine derivatives, triallylmethane derivatives, bisphenylmethane derivatives, xanthene derivatives, fluoran derivatives, and spiropyran derivatives. Among these, amines having a low-molecular aromatic ring are preferable as the anodic EC molecule, and dihydrophenazine derivatives are most preferable.

(Cathodic EC Compound)

The cathodic EC compound is a material of which light absorption characteristics are changed by a reduction reaction in which electrons are supplied from an ordinary electrode to the EC compound on a cathode in an optical wavelength region that the element is associated with. Typical examples include materials that change from a light transmitting state to a light absorbing state. In the description of the present specification, the reductant of the cathodic EC compound is in a light absorption state in the light wavelength region of an object of the device, and is referred to as “colored material”. The oxidant of the cathodic EC compound is in a light-transmitting state and is referred to as “decolorized material”.

Examples of the cathodic EC compound include a pyridine compound such as viologen and a quinone compound. Among them, pyridine compounds such as viologen are most preferably used.

[Method for Forming EC Layer]

As a method for introducing a solution containing an EC compound into an EC element, for example, an opening is formed in the electrodes 11a and 11b or a part of the peripheral seal 12 when the facing electrodes 11a and 11b are joined, and then the solution is injected through the opening. Specific methods for injecting a solution containing an EC compound into a cell include a vacuum injection method, an atmospheric injection method, a meniscus method, and the like. After the solution containing the EC compound is injected into the cell, the opening is sealed to stably hold the solution in the cell.

<Peripheral Seal 12>

The first electrode 11a and the second electrode 11b are preferably joined by the peripheral seal 12 with both electrode surfaces facing each other. The peripheral seal 12 not only retains the spatial arrangement of the first electrode 11a and the second electrode 11b, but also plays a role of preventing leakage of the EC layer 13 to the outside of the EC element and protecting it from contact with an external substance.

From the above viewpoint, the material constituting the peripheral seal 12 is preferably composed of a material which is chemically stable, has low moisture permeability and low gas permeability, and has low solubility in the solvent contained in the EC layer 13. For example, an inorganic material such as glass frit, an organic material such as epoxy resin or acrylic resin, a metal or the like can be used. The peripheral seal may have a function of defining a distance between the first electrode 11a and the second electrode 11b by including a spacer material or the like. If the peripheral seal 12 does not have the function of defining the distance between the first electrode 11a and the second electrode 11b, a separate spacer may be provided to maintain the distance between the two electrodes. As the material of the spacer, inorganic materials such as silica beads and glass fibers, and organic materials such as polyimide, polytetrafluoroethylene, polydivinylbenzene, fluororubber, and epoxy resin can be used. In this case, the spacer can define and maintain a distance between the first electrode 11a and the second electrode 11b constituting the EC element.

The inventors have found that either the anodic EC compound or the cathodic EC compound in the EC layer 13 may be colored in the vicinity of the peripheral seal 12 in preference to the other. Here, the term “colored in preference” means that when the EC element is driven and the optical density of the element reaches a stable state in which the optical density changes in the vicinity of the target density, the colored material of either the anodic EC compound or the cathodic EC compound is present more than the colored material of the other. For example, the term “The anodic EC compound is preferentially colored in the vicinity of the peripheral seal 12.” means that, in the vicinity of the peripheral seal 12, at the stage where the optical density of the element is stabilized after the EC element is driven, more colored materials of the anodic EC compound are present than colored materials of the cathodic EC compound. Specifically, it is meant that the color of the colored material of the anodic EC compound is more strongly expressed than the color of the colored material of the cathodic EC compound. As described above, when a preferential coloring of the anodic EC compound or the cathodic EC compound is observed in the vicinity of the peripheral seal 12, a color difference occurs in the vicinity of the peripheral seal 13 in the EC layer 12 and in other regions when the EC element is driven, and color unevenness occurs in the element surface.

FIG. 2 shows a typical distribution of a preferential coloring region seen in the vicinity of the peripheral seal 12. FIG. 2 depicts a perspective view of the EC element from a direction perpendicular to the element surface. As shown in FIG. 2, the preferential coloring regions are generated in two regions, i.e., “peripheral seal nearest region 13a” and “peripheral seal quasi-nearest region 13b”. Here, the “peripheral seal nearest region 13a” is a region in the EC layer 13 near the boundary where the peripheral seal 12 and the EC layer 13 are in contact, and the “peripheral seal quasi-nearest region 13b” is an outer edge of a region in the EC layer 13 not including the peripheral seal nearest region 13a. The region of the “peripheral seal nearest region 13a” has a width of about from 50 to 1000 μm from the boundary of the peripheral seal 12 on the side in contact with the EC layer 13. Also, depending on the appearance of the preferential coloring in the “peripheral seal nearest region 13a”, the peripheral seal 12 is classified into 3 types, i.e., an anode preferential peripheral seal, a cathode preferential peripheral seal, and other peripheral seals not corresponding to these two. Hereinafter, two types of peripheral seals, i.e., an anode preferential peripheral seal and a cathode preferential peripheral seal, are described.

[Anode Preferential Peripheral Seal]

The anode preferential peripheral seal is defined as a peripheral seal 12 that exhibits preferential coloration of the anodic EC compound in the peripheral seal nearest region 13a. In the anode preferential peripheral seal, the cathodic EC compound is preferentially colored in the peripheral seal quasi-nearest region 13b. The sealing material exhibiting properties as an anode preferential peripheral seal can be characterized in that it is composed of a resin having a relatively large polarity, and that it contains an oxidizing compound. The reason for the former is as follows. While a decolorized material of a viologene-based compound which is a typical cathodic EC compound has a positive charge, a decolorized material of the anodic EC compound such as an aromatic amine-based compound including triphenylamines and phenazines, or a thiophene-based compound does not have a charge. Therefore, the decolorized material of the cathodic EC compound has a greater polarity than the decolorized material of the anodic EC compound.

As is described later, a thin film made of a material constituting the peripheral seal exists on the electrode surface in the peripheral seal nearest region 13a and the peripheral seal quasi-nearest region 13b. The peripheral seal nearest region 13a has a thickness of the thin film relatively greater than that of the peripheral seal quasi-nearest region 13b. Therefore, in the region of the peripheral seal nearest region 13a, when the peripheral seal is composed of a resin having a large polarity, the interaction between the decolorized material of the cathodic EC compound having a high polarity and the resin having a large polarity is relatively large as compared with the decolorized material of the anodic EC compound having a low polarity. As a result, the movement of the decolorized material of the cathodic EC compound to the electrode surface is greatly inhibited as compared with the decolorized material of the anodic EC compound. Consequently, the anodic EC compound is preferentially colored at the peripheral seal nearest region 13a. Examples of the seal satisfying the above features include a peripheral seal having an epoxy resin. The reason for the latter is as follows. When the oxidizing compound is contained in the peripheral seal, proton addition to the anodic EC compound existing in the vicinity of the peripheral seal or removal of electrons from the anodic EC compound may cause oxidation. When the oxidized anodic EC compound has absorption in the visible region, absorption due to the oxidized colored species of the anodic EC compound is strongly exhibited in the vicinity of the peripheral seal.

Examples of the material satisfying the above characteristics include a curing agent or a curing accelerator for a thermosetting epoxy resin or a photocurable acrylic resin, and specifically, Lewis acids by-produced from an onium salt such as an acid anhydride, a phenolic resin or an antimony compound. More specific examples of curing agents and curing accelerators that can be anodic preferential peripheral seals include: potential thermal acid generators made of onium salts such as sulfonium salts, benzothiazolium salts, ammonium salts, phosphonium salts combined with antimonate or phosphate systems; potential photoacid generators of halogen-containing triazine compounds, diazoketone compounds, onium salt compounds, and sulfonic acid compounds; phenolic resin curing agents such as novolac resins and cresol resins; acid anhydrides such as phthalic anhydride, maleic anhydride, and pyromellitic anhydride; and curing accelerators such as p-toluenesulfonate and phenol salts of DBU (1,8-Diazabicyclo (5,4,0)-undecene-7), p-toluenesulfonate salts of DBN (1,5 Diazabicyclo (4,3,0)-nonene-5), and p-toluenesulfonate and phenol salts of DBN. The type of the peripheral seal is determined according to a method for discriminating the type of the peripheral seal, which is described later, regardless of the presence or absence of the component.

[Cathode Preferential Peripheral Seal]

The cathode preferential peripheral seal is defined as a peripheral seal 12 indicating a preferential coloration of the cathodic EC compound in the peripheral seal nearest region 13a. In the cathode preferential peripheral seal, the anodic EC compound is preferentially colored in the peripheral seal quasi-nearest region 13b. The sealing material exhibiting properties as a cathode preferential peripheral seal can be characterized in that it is composed of a material having a relatively small polarity, and that it contains a reductive compound. The reason for the former is as follows. As described above, a thin film having a relatively large thickness exists on the surface of the electrode in the peripheral seal nearest region 13a. Therefore, when the peripheral seal is made of a material having a small polarity, the interaction between the decoloring body of the anodic EC compound having a small polarity and the peripheral seal having a small polarity is relatively large as compared with the decoloring body of the cathodic EC compound having a high polarity in the peripheral seal nearest region 13a. As a result, the movement of the anodic EC compound to the electrode surface of the decolorized material is greatly inhibited as compared with the decolorized material of the cathodic EC compound having a large polarity. Consequently, the cathodic EC compound is preferentially colored in the peripheral seal nearest region 13a. Examples of the seal satisfying the above characteristics include a peripheral seal having synthetic rubber.

The reason for the latter is as follows. When the reducing compound is contained in the peripheral seal, the reducing compound existing on the outermost surface of the film or the eluted reducing compound may cause a reduction reaction of the cathodic EC compound existing near the peripheral seal. As a result, the cathodic EC compound is strongly colored in the peripheral seal nearest region 13a. Examples of the sealing material satisfying the above characteristics include a peripheral seal containing a curing agent and a curing accelerator such as a low-molecular amine compound, a polyamideamine, an imidazole compound and a triarylphosphine compound. More specific examples of curing agents and curing accelerators that can be cathode preferential peripheral seals include potential photoamine generators such as carbamates, carbamoyloximes, aromatic sulfonamides, α-lactones, benzhydryl ammonium salts, imidazole salts, and amidine salts; potential thermoamine generators of piperidine carboxylates; low molecular weight amines of aliphatic polyamines such as triethylenetetramine and aromatic polyamines such as diaminodiphenylmethane; and sensitizers such as alkylaminobenzophenone and curing accelerators such as DBU (1,8-Diazabicyclo (5,4,0)-undecene-7) and DBN (1,5 Diazabicyclo (4,3,0)-nonene-5). The type of the peripheral seal is determined according to a method for discriminating the type of the peripheral seal, which is described later, regardless of the presence or absence of the above-mentioned component.

[Method for Discriminating Type of Peripheral Seal]

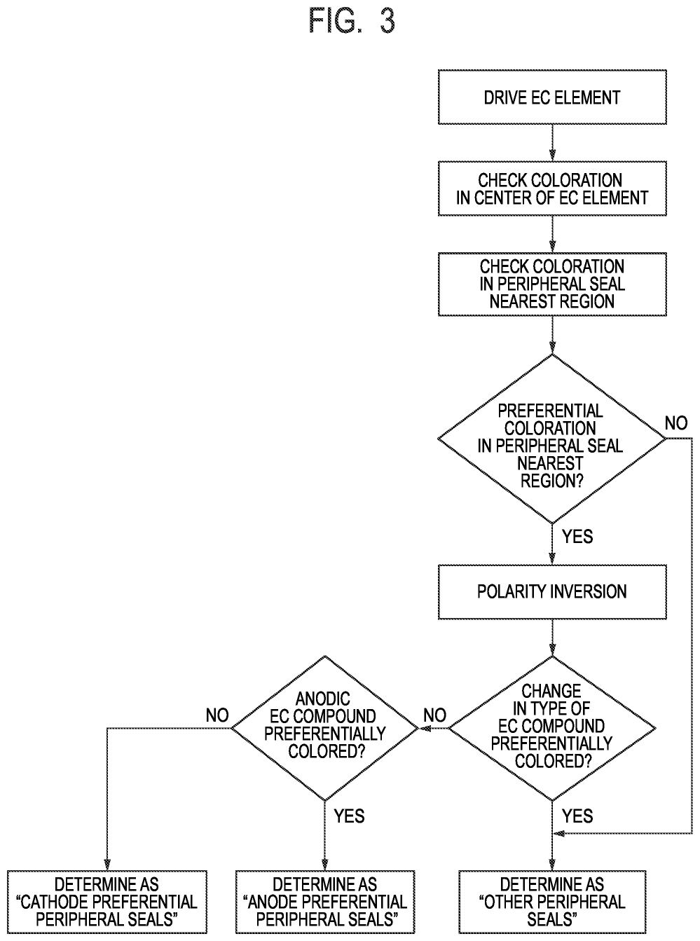

The peripheral seals are classified into the anode preferential peripheral seals, the cathode preferential peripheral seals, and other peripheral seals not corresponding to these two. A method for performing these classifications is described with reference to the flowchart of FIG. 3.

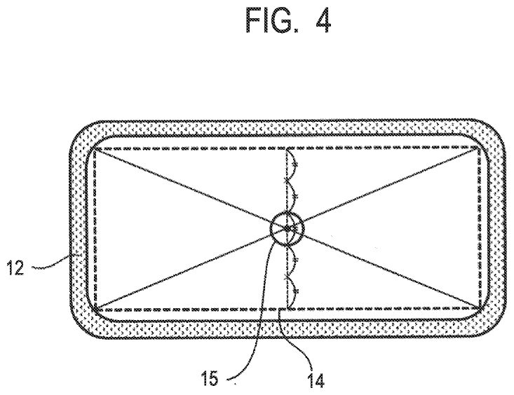

First, a voltage is applied to the EC element to bring it into a colored state, and the coloring of the center portion of the EC element and the coloring of the peripheral seal nearest region 13a are confirmed. Next, the coloring of the center portion of the EC element is compared with the coloring of the peripheral seal nearest region 13a. A method of defining the center portion of the EC element is described with reference to FIG. 4. First, an area inside the peripheral seal 12 is defined by a rectangular area 14 having a maximum area. The center of gravity of the above rectangular region is defined as a center, and a circular region 15 having a diameter ⅕ times the length of the short side of the rectangular region is defined as a center portion of the EC element.

When the coloration to an area of the peripheral seal nearest region 13a is confirmed, the coloration to an area in the EC layer located within 1 mm from the boundary between the peripheral seal and the EC layer is confirmed. And then, if the coloration of the EC compound is shown more strongly in a part or the entire part of the area than in the center of the EC element, it is determined as “with preferential coloration”.

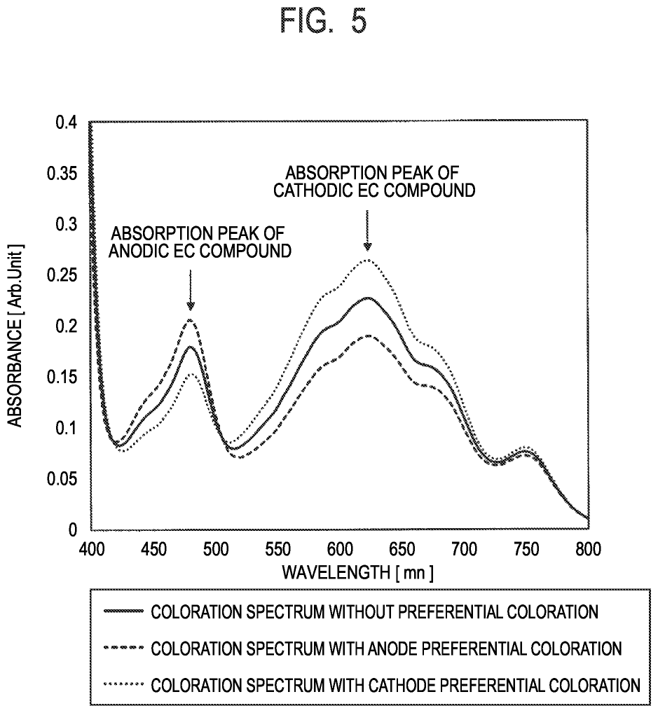

According to the above-mentioned conditions for defining the center portion, the coloring of the center portion of the EC element is the coloring in the region of the EC layer away from the vicinity of the peripheral seal, and reflects the coloring of the EC element when there is no color unevenness, that is, no preferential coloring. Therefore, when the coloring of the anodic EC compound or the cathodic EC compound is strongly shown in the nearest region of the peripheral seal as compared with the center of the EC element, it is determined that there is a preferential coloring in the nearest region of the peripheral seal. The color comparison can be performed by visual observation, image analysis by a camera or the like. Further, the coloring spectra of the center portion of the EC element and the peripheral seal nearest region 13a may be acquired and compared. FIG. 5 shows an example of a coloring spectrum when there is no preferential coloring, a coloring spectrum when the anodic EC compound is preferentially colored, and a coloring spectrum when the cathodic EC compound is preferentially colored. As described above, with the preferential coloring, the absorption corresponding to the anodic EC compound or the cathodic EC compound to be preferentially colored becomes larger and the absorption corresponding to the other EC compound becomes smaller as compared with no preferential coloring. Therefore, the color changes as compared with the case where there is no preferential coloring, which allows to determine the presence or absence of the preferential coloring and the type of the EC compound to be preferentially colored based on visual and image comparison or a shape change in the spectrum. As a result of confirming the coloring of the center portion of the EC element and the peripheral seal nearest region 13a, the peripheral seal is determined to be “Other peripheral seals” if there is no preferential coloring. If the preferential coloring is confirmed, the type of the peripheral seal is determined by the following process.

The polarity of the voltage applied to the EC element is inverted, and the coloring of the nearest region of the peripheral seal is confirmed again. If the type (anodic EC compound/cathodic EC compound) of the EC compound to be preferentially colored is changed, the peripheral seal is determined to be “other peripheral seals”.

If the polarity inversion does not change the type of the EC compound to be preferentially colored, the determination is made as follows. When the EC compound preferentially colored in the peripheral seal nearest region 13a is an anodic EC compound, the peripheral seal is determined to be an “anode preferential peripheral seal”. When the EC compound preferentially colored in the peripheral seal nearest region 13a is a cathodic EC compound, the peripheral seal is determined to be a “cathode preferential peripheral seal”.

The reason for performing the determination by the polarity inversion is described below. Even if the peripheral seal is not the “anode preferential peripheral seal” or the “cathode preferential peripheral seal” but in fact the “other peripheral seals”, preferential coloring may occur in the vicinity of the peripheral seal. A typical example of the above phenomenon is shown in a case in which either one of the electrodes has an obstacle that prevents the EC compound from moving to the electrode surface. In such a case, coloring of the EC compound in accordance with the polarity of the electrode preferentially occurs in the one electrode having no obstacle during EC driving. (Such a phenomenon may be described as unevenness in color of an electrode obstacle.) For example, if the cathode has such an obstacle but the anode has no such an obstacle, the coloring of the anodic EC compound takes preference. If the anode has such an obstacle but the cathode has no such an obstacle, the coloring of the cathodic EC compound takes preference. In the vicinity of the peripheral seal 12, there may be a region in which one electrode is covered with a thin film made of a material constituting the peripheral seal, but the other electrode is not covered with the same. In such a region, unevenness in the color due to electrode obstacles appears significantly.

The unevenness in color due to electrode obstacles can be characterized in that one EC compound to be preferentially colored is changed to the other EC compound by inverting the polarity of a voltage applied from the outside when driving the EC element. Specifically, by inverting the polarity of the voltage, the preferential coloring of the anodic EC compound is changed to the preferential coloring of the cathode EC compound, and the preferential coloring of the cathode EC compound is changed to the preferential coloring of the anode EC compound. On the other hand, the color unevenness caused by the anode preferential peripheral seal or the cathode preferential peripheral seal is characterized in that the type of the EC compound to be preferentially colored is not changed by inverting the polarity of the voltage applied, which allows the discrimination from the color unevenness shown in the vicinity of the non-preferential peripheral seal.

[Correlation Between the Concentration of the EC Compound and Color Unevenness Caused by the Peripheral Seal 12]

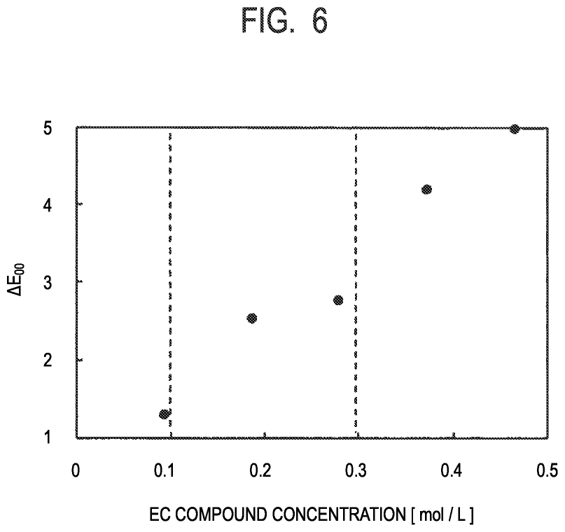

FIG. 6 shows the correlation between the concentration of the EC compound and the degree of color unevenness caused by the peripheral seal 12. The EC compound concentration shown on the horizontal axis in FIG. 6 indicates the sum of the concentrations of the anodic EC compound and the cathodic EC compound contained in the EC layer 13. In the acquisition of the data shown in FIG. 6, the concentration ratio “A/C” of the anode compound to the cathode EC compound is set to A/C=1. The degree of color unevenness on the vertical axis of FIG. 6 (ΔE₀₀) is described later. It can be seen from FIG. 6 that, in a concentration range where the concentration of the EC compound is 0.1 mol/L or more, the degree of color unevenness caused by the peripheral seal 12 increases, and in the concentration range where the concentration of the EC compound is 0.3 mol/L or more, the degree of color unevenness further increases. One of the objects of the present invention is to reduce the degree of color unevenness caused by the peripheral seal 12, and the effect of the present invention is strongly exhibited in a concentration range of 0.1 mol/L or more, and particularly in a concentration range of 0.3 mol/L or more.

<<Generation Mechanism of Color Unevenness Caused by the Peripheral Seal 12>>

As shown in Table 1, when the preferential coloring of the anodic EC compound is shown in the peripheral seal nearest region 13a (in other words, when the peripheral seal 12 is an anode preferential peripheral seal), the preferential coloring of the cathodic EC compound occurs simultaneously in the peripheral seal quasi-nearest region 13b. In addition, when the preferential coloring of the cathodic EC compound is shown in the peripheral seal nearest region 13a (in other words, when the peripheral seal 12 is a cathode preferential peripheral seal), the preferential coloring of the anodic EC compound simultaneously occurs in the peripheral seal quasi-nearest region 13b.

TABLE 1

| | Peripheral seal nearest | Peripheral seal |
|---|---|---|
| | region 13a | quasi-nearest region 13b |
| Anode preferential | Anodic EC compound | Cathodic EC compound |
| peripheral seal | Preferential coloration | Preferential coloration |
| Cathode preferential | Cathodic EC compound | Anodic EC compound |
| peripheral seal | Preferential coloration | Preferential coloration |

In order to identify the cause of the distribution of such coloring when driving the EC element, the inventors observed and analyzed the surfaces of the electrodes 11a, 11b near the peripheral seal 12. As a result, it was found that a thin film made of components constituting the peripheral seal 12 was formed on the surfaces of the electrodes 11a, 11b in the vicinity of the peripheral seal 12. In addition, electrochemical measurements were performed on the anode preferential peripheral seal. Specifically, electrodes having thin films with various thicknesses were prepared, and the coloring reactivity of the anodic and cathodic EC compounds on the surface of the thin film was examined by detecting the current during the coloring reaction. As a result of the examination, the inventors found out the following facts.

(1) On the electrode where the thin film is present, the coloring reaction rate of the cathodic and anodic EC compound decreases as compared with the electrode where the thin film is not present, and the degree thereof increases as the film thickness increases.

(2) On the electrode having the smallest film thickness, the coloring reaction rate of the anodic EC compound decreases, and the magnitude relationship of the coloring reaction rate becomes higher in the cathodic EC compound than the anodic EC compound.

(3) On the electrodes having larger film thicknesses, the coloring reaction rate still greatly decreases, but the magnitude relationship of the coloring reaction rate becomes higher in the anodic EC compound than the cathodic EC compound.

These three points are experimental facts concerning the anode preferential peripheral seal. In the cathode preferential peripheral seal, the fact (1) is observed as well, but the magnitude relationship between the anode preferential peripheral seal and the coloring reaction rate is reversed with respect to the facts (2) and (3). That is, when the thickness of the thin film is smaller, the coloring reaction rate of the anodic EC compound is higher than that of the cathodic EC compound. When the thickness of the thin film is larger, the coloring reaction rate of the cathodic EC compound is higher than that of the anodic EC compound.

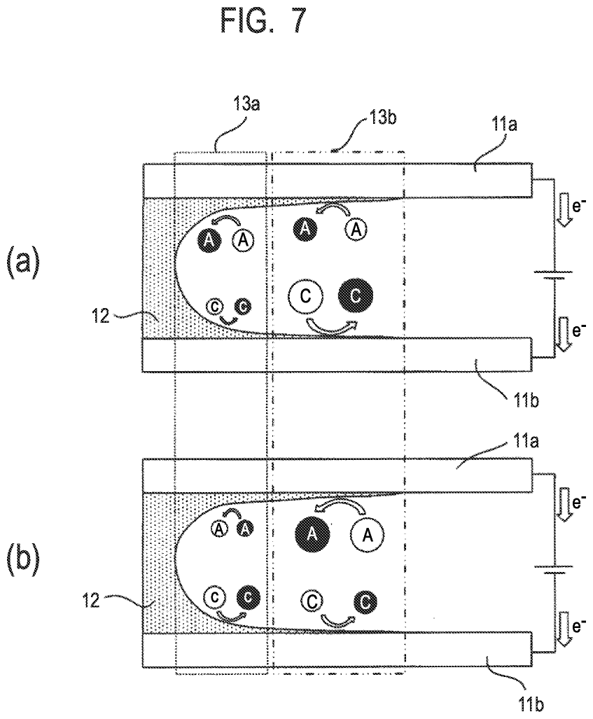

FIG. 7 is a diagram schematically showing the generation mechanism of color unevenness derived from these experimental facts. FIG. 7 shows the vicinity of the peripheral seal 12 in a cross-sectional view of the EC element. Here, the cross section shows a plane orthogonal to the element plane. The upper part (a) of FIG. 7 shows the generation mechanism of color unevenness when the peripheral seal 12 is the anode preferential peripheral seal, and the lower part (b) of FIG. 7 shows the generation mechanism of color unevenness when the peripheral seal 12 is the cathode preferential peripheral seal. In FIG. 7, the first electrode 11a is an anode electrode and the second electrode 11b is a cathode electrode. In addition, the “A” in a white circle indicates a decolorized material of the anodic EC compound, and the “A” in a black circle indicates a colored material of the anodic EC compound. Similarly, the “C” in a white circle indicates a decolorized material of the cathodic EC compound, and the “C” in a black circle indicates a colored material of the cathodic EC compound.

As shown in (a) of FIG. 7, when the peripheral seal 12 is an anode preferential peripheral seal, more colored materials of the cathodic EC compound are generated than colored materials of the anodic EC compound in peripheral seal quasi-nearest region 13b where the thickness of the thin film (peripheral seal 12) on the electrode is relatively small. Since both of the anode and the cathode electrodes form an electrically closed circuit while the EC element is driven, the amount of colored substances of both compounds are basically equal in the whole element. Therefore, it is necessary to compensate for the imbalance of the colored material generated in the peripheral seal quasi-nearest region 13b. This imbalance is compensated by an increase in the amount of the colorant of the anodic EC compound than the amount of the colorant of the cathodic EC compound in the peripheral seal nearest region 13a.

As shown in (b) of FIG. 7, when the peripheral seal 12 is a cathode preferential peripheral seal, more colored materials of the anodic EC compound are generated than colored materials of the cathodic EC compound in peripheral seal quasi-nearest region 13b where the thickness of the thin film on the electrode is relatively small. As described above, since both electrodes form an electrically closed circuit, it is necessary to compensate for the imbalance of the colored material generated in the peripheral seal quasi-nearest region 13b. This imbalance is compensated by an increase in the amount of the colorant of the cathodic EC compound than the amount of the colorant of the anodic EC compound in the peripheral seal nearest region 13a.

<<Method for Solving Color Unevenness Caused by Peripheral Seal>>

The inventors of the present invention have considered that, among the peripheral seal nearest region 13a and the peripheral seal quasi-nearest region 13b, the peripheral seal quasi-nearest region 13b which has the larger amount of reaction charge of the EC compound is dominant in the occurrence of color unevenness, and have attempted to solve the imbalance of colored materials in this area.

In EC elements, the reaction rate is generally determined by two processes, i.e., the “electron transfer process” and the “mass transport process”. The inventors attempted to control the “mass transport process” among them. Specifically, it is proposed to improve the balance of the amount of colored substances by reducing the concentration of the EC compound in the EC layer 13 where more colored substances are generated in the peripheral seal quasi-nearest region 13b compared to the other EC compound, and by increasing the concentration of the other EC compound in the EC layer 13. That is, in the anode preferential peripheral seal, the concentration ratio “A/C” of the anode compound to the cathode EC compound is set larger than 1. Preferably, A/C is greater than 1 but less than 2. More preferably, the A/C is greater than 1.2 but less than 1.8. In the anode preferential peripheral seal, a “C/A” which is a concentration ratio of the cathode compound to the anode EC compound is set larger than 1. Preferably, C/A is greater than 1 but less than 2. More preferably, the C/A is greater than 1.2 but less than 1.8.

As a result, a difference is made between the anodic EC compound and the cathodic EC compound in the amount of the EC compound that can be supplied to the electrode, the difference in reaction rate due to the thin film composed of the components constituting the peripheral seal 12 is canceled, and the amount of the colored substances generated can be equalized in both materials. It should be noted that, in regions other than the peripheral seal nearest region 13a and the peripheral seal quasi-nearest region 13b, even if a difference is provided in the concentrations of the anodic EC compound and the cathodic EC compound, no change occurs in color at the time of coloring. As described above, when driving the EC element, both electrodes of the anode and the cathode are electrically connected. Therefore, in a region where there is no element inhibiting the coloring reaction on the electrode surface, the amount of reaction charge in the anode becomes equal to the amount of reaction charge in the cathode. Thus, even if the A/C or the C/A is changed from 1, the amount ratio of colored materials of the anodic EC compound to the cathodic EC compound at the time of driving the EC element becomes 1:1 in the regions other than the peripheral seal nearest region 13a and the peripheral seal quasi-nearest region 13b.

<<Evaluation Method of Color Unevenness>>

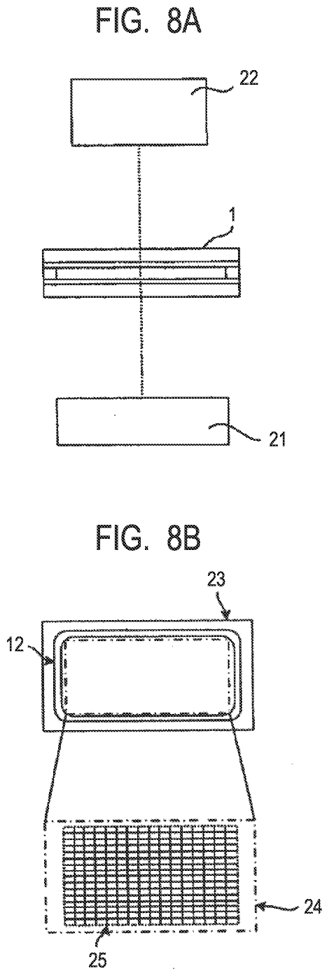

A method for evaluating color unevenness, which is color unevenness in an element, is described with reference to FIGS. 8A and 8B. FIG. 8A shows the components of the evaluation system and their arrangement. FIG. 8B is a diagram schematically showing the relationship between the acquired image and the analysis region obtained thereby.

A surface illumination 21 and an imaging apparatus 22 are arranged such that an optical axis is perpendicular to an element surface of the transmission type EC element 1. Images are acquired over time for 24 hours from immediately after driving the EC element 1. An area surrounded by the peripheral seal 12 in the image is approximated to a rectangular area 24 having a maximum area, and a rectangular area determined by the following 4 conditions applied to the rectangular area 24 is set as an analysis region 25 for performing an analysis described later.

(i) The longer side has a length 0.8 times as long as that of the original rectangle;

(ii) The short side has a length 0.74 times as long as that of the original rectangle;

(iii) The center of gravity coincides with each other; and

(iv) The long side is parallel to the long side of the original rectangle.

Each of the R value, B value, and G value of all pixels included in the analysis region 25 are averaged to obtain a reference RGB value. Further, the analysis region 25 was divided into 16×16 rectangular regions (in total 256 regions), and the color difference ΔE₀₀ between the average RGB value in each region and the reference RGB value was calculated using a color difference expression based on the definition of CIEDE2000. The color difference equations of CIEDE2000 was used with reference to Gaurav Sharma, Wencheng Wu, Edul N. Dalal; “The CIEDE2000 Color-Difference Formula: Implementation Notes, Supplementary Test Data, and Mathematical Observations”, Color Research & Applications 30 (1), 21-30 (2005). The maximum value between the color difference ΔE₀₀ obtained at each point as shown above is defined as the absolute value of the color unevenness at each point of time.

Applications of the EC element 1 according to the present embodiment include a display device, a variable reflectance mirror, a variable transmission window, and an optical filter. If color unevenness occurs in these applications, the color balance of the transmitted light or the reflected light is unintentionally changed at each point on the surface of the EC element, which is undesirable in any application.

As an example of the value of ΔE₀₀, a case where the EC element is used as an optical filter of a camera, in particular, as an ND filter is considered below. When color unevenness is generated in an EC element used as an ND filter, a color tone changes at each point of an image obtained by imaging. Specifically, when the peripheral seal 12 used for the EC element is an anode preferential peripheral seal, the coloring (Typically green to blue) of the cathodic compound strongly appears in the peripheral seal quasi-nearest region 13b. On the other hand, when the peripheral seal 12 used for the EC element is a cathode preferential peripheral seal, the coloring (Typically red) of the anodic EC compound strongly appears in the peripheral seal quasi-nearest region 13b. Thus, in a case where the degree of color unevenness caused by the peripheral seal 12 is high, the quality of the acquired image is significantly degraded, which is not preferable.

As is clear, when the EC element is used for an optical filter or the like, it is required that the degree of color unevenness is suppressed. Specifically, the color difference ΔE₀₀ is preferably 4.5 or less. Further, the color difference ΔE₀₀ is preferably 3.2 or less. This is because the two colors are in general determined to be the same color through the human visual perception when the color difference between the two colors is 3.2 or less. That is, even in a case where the EC element is used as an optical filter, it is important to satisfy the condition that the maximum value of ΔE₀₀ in the plane is 3.2 or less in order to maintain the quality of the acquired image. Satisfying the above condition allows to suppress a problem such that an object appears greener or redder in peripheral areas of a screen compared to the center portion of the screen.

### Advantages of the Present Invention

The present invention is directed to a complementary EC element in which an EC layer 13 including an anodic EC compound and a cathodic EC compound is disposed in a space defined by two electrodes 11a, 11b facing each other and a peripheral seal 12, the EC compounds having an oxidation-reduction reaction in the electrodes. In this EC element, one of the anodic and cathodic EC compounds is preferentially colored in the vicinity of the peripheral seal 12 when driving, and color unevenness may occur in the element surface. From the viewpoint of responsiveness and optical density, it is required to increase a concentration of the EC compound, but the degree of color unevenness caused by the peripheral seal 12 increases as the concentration of the EC compound in the EC layer 13 (i.e., a sum of the concentrations of the anodic and cathodic EC compounds) increases. According to the present invention, the color unevenness caused by the peripheral seal 12 can be reduced by properly adjusting the concentration ratio of the anodic EC compound and the cathodic EC compound even if the concentration of the EC compounds is increased.

<<Optical Filter, Lens Unit, and Imaging Apparatus>>

The EC element 1 can be used for an optical filter. An optical filter according to another embodiment of the present invention includes an EC element 1 and an active element connected to the EC element 1. The active element is an element for adjusting the amount of light transmitted through the EC element, and it may be a switching element for controlling the transmissivity of the EC element. Examples of the switching elements include a TFT and a MIM element. The TFT is also referred to as a thin film transistor, and a semiconductor or an oxide semiconductor is used as a constituent material thereof. Specifically, amorphous silicon, low-temperature polysilicon, semiconductors using InGaZnO as a constituent material, and the like can be used.

The EC element 1 can be used for an imaging apparatus and a lens unit. An imaging apparatus according to another embodiment of the present invention includes the above-described optical filter having an EC element, and a light receiving element 110 for receiving light passing through the optical filter.

The lens unit according to another embodiment of the present invention includes the optical filter having an EC element and an imaging optical system. The imaging optical system is preferably a lens group having a plurality of lenses. The optical filter may be arranged such that the light having passed through the optical filter passes through the imaging optical system, or the light having passed through the imaging system passes through the optical filter. The optical filter may be disposed between the plurality of lenses. The optical filter is preferably provided on the optical axis of the lens. The amount of light to be passing through the imaging optical system or the amount of light having passed through the imaging optical system can be adjusted by the optical filter.

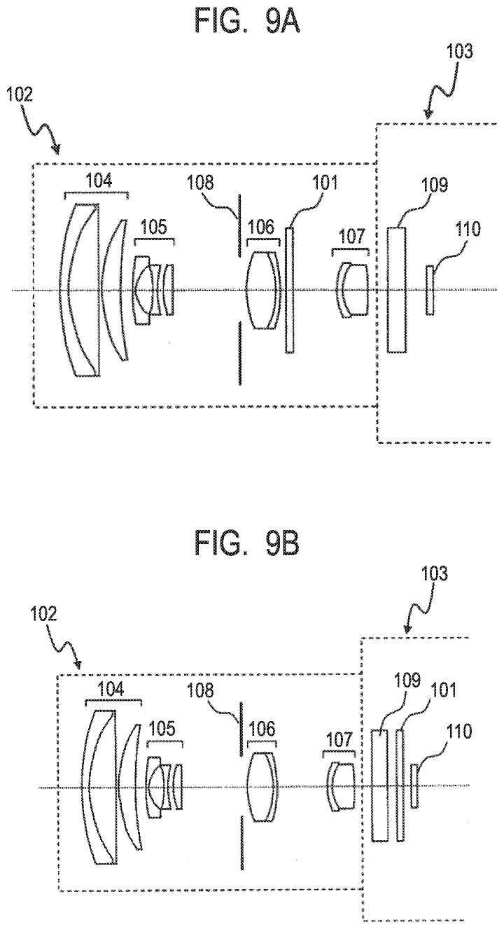

FIGS. 9A and 9B are diagrams schematically showing an example of an imaging apparatus and a lens unit using an optical filter. FIG. 9A shows an imaging apparatus having a lens unit 102 using an optical filter 101, and FIG. 9B shows an imaging unit 103 having an optical filter 101. As shown in FIG. 9A, the lens unit 102 is detachably connected to the imaging unit 103 via a mount member (not shown).

The lens unit 102 is a unit having a plurality of lenses or a lens group. For example, in FIG. 9A, the lens unit 102 is a rear-focus type zoom lens that perform the focusing behind the aperture. The lens unit 102 has four lens groups, i.e., in order from the object side (the left side of a page), a first lens group 104 of positive refractivity, a second lens group 105 of negative refractivity, a third lens group 106 of positive refractivity, and a fourth lens group 107 of positive refractivity. The image magnification is performed by changing a gap between the second lens group 105 and the third lens group 106, and the focusing is performed by moving a part of the fourth lens group 107. The lens unit 102 has, for example, an aperture stop 108 between the second lens group 105 and the third lens group 106, and the optical filter 101 between the third lens group 106 and the fourth lens group 107. The light passing through the lens unit 102 is arranged to pass through the lens groups 102 to 107, the aperture stop 108 and the optical filter 101, and the amount of light can be adjusted by using the aperture stop 108 and the optical filter 101.

The configuration of the lens unit 102 can be suitably changed. For example, the optical filter 101 may be disposed in front of (the subject side) or behind (the imaging unit 103 side) the aperture stop 108. The optical filter 101 may be disposed in front of the first lens group 104, or behind the fourth lens group 107. If the optical filter is disposed at a position where light converges, there is an advantage that an area of the optical filter 101 can be reduced. Instead of the rear focus type, a type of the lens unit 102 can be suitably selected. The type may be an inner focus type in which the focusing is performed before the aperture. Instead of the zoom lens, other lenses such as a fisheye lens or a macro lens can be properly selected.

The imaging unit 103 has a glass block 109 and a light receiving element 110. The glass block 109 is a glass block such as a low-pass filter, a face plate or a color filter. The light receiving element 110 is a sensor unit for receiving the light passing through the lens unit 102, and an image pickup element such as a CCD or a CMOS can be used as the sensor unit. In addition, an optical sensor such as a photodiode may be used as the sensor unit to obtain and output information on the light intensity or wavelength of light.

As shown in FIG. 9A, if the optical filter 101 is incorporated in the lens unit 102, the driving means such as an active element may be disposed in the lens unit 102 or may be disposed outside the lens unit 102. If the driving means is arranged outside the lens unit 102, the EC elements inside and outside the lens unit 102 are connected to the driving means through wiring to control the driving.

As shown in FIG. 9B, the imaging apparatus itself may include an optical filter 101. The optical filter 101 may be disposed at a suitable position inside the imaging unit 103, and the light receiving element 110 may be disposed so as to receive light passing through the optical filter 101. In FIG. 9B, for example, the optical filter 101 is disposed immediately in front of the light receiving element 110. If the imaging apparatus itself incorporates the optical filter 101, the lens unit 102 itself to be connected need not have the optical filter 101, which allows to configure an imaging apparatus with a dimmer using an existing lens unit.

Such an imaging apparatus is applicable to a product having a combination of a light amount adjustment function and a light receiving element. For example, the present invention can be applied to a camera, a digital camera, a video camera, and a digital video camera, and can also be applied to a product including an imaging apparatus such as a mobile phone, a smart phone, a personal computer, or a tablet.

Using the optical filter according to the present embodiment as a dimming member allows to properly vary the amount of dimming by a single filter, which brings advantages such as reduction in the number of components and space saving.

The optical filter, the lens unit, and the imaging apparatus of the present embodiment allow to suppress color unevenness caused by the peripheral seal in the EC element. Therefore, the present invention allows to suppress deterioration in the quality of an image obtained by imaging the light transmitted through or reflected by the optical filter.

<<Window Member>>

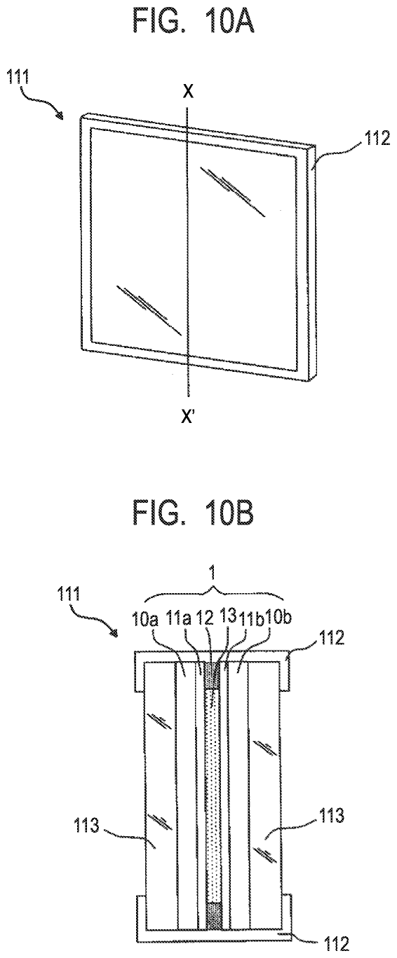

A window member according to another embodiment of the present invention has the EC element 1 and an active element connected to the EC element. FIGS. 10A and 10B schematically show an example of the window member according to the present embodiment. FIG. 10A is a perspective view, and FIG. 10B is a sectional view taken along the line X-X′ shown in FIG. 10A.

A window member 111 shown in FIGS. 10A and 10B is a dimming window, and comprises the EC element 1, a transparent plate 113 (a pair of substrates) for sandwiching the EC element 1, and a frame 112 for surrounding and integrating the whole components. The active element is an element for adjusting the amount of light transmitted through the EC element 1. The active element may be directly connected to the EC element 1, or indirectly connected to the EC element 1. The active element may be integrated in the frame 112, or it may be disposed outside the frame 112 and connected to the EC element 1 through wiring.

The transparent plate 113 is not limited to a particular material as long as it is made of a material having a high light transmittance, but it is preferably made of a glass material in view of its use as a window. In FIG. 10B, the EC element 1 is a component independent of the transparent plate 113, but the substrate 10 of the EC element 1 may be regarded as the transparent plate 113, for example.

The frame 112 is made of any material and it can be a frame as long as it covers at least a part of the EC element 1 and has an integrated form.

The dimming window can also be referred to as a window member having an electronic curtain. A sufficient amount of transmitted light can be obtained with respect to incident light when the EC element 1 is in a decolorized state, and optical characteristics such that incident light is reliably shielded and modulated can be obtained in a colored state. The window member according to the present embodiment can be applied, for example, for adjusting the amount of sunlight coming into a room in the daytime. Since it can be applied to the adjustment of heat quantity in addition to the light quantity of the sun, it can be used for controlling brightness and temperature in a room. It can also be applied as a shutter for blocking a view from the outside to the inside. Such dimming windows can be applied not only to glass windows for buildings but also to windows for vehicles such as automobiles, trains, airplanes, and ships, and filters for display screens of clocks and cellular phones.

### Example

The present invention is described more specifically with reference to the following examples, but the present invention is not limited to these examples.

<<Fabrication of EC Elements>>

The EC element having the structure shown in FIG. 1 was fabricated by the following method.

Two transparent conductive glass substrates (10a, 10b) on which an indium doped tin oxide (ITO) film (i.e., the electrodes 11a, 11b) had been formed were prepared. For one substrate, two through-holes (not shown) were formed by blasting.

Then, the gap control particles (Micropearl SP 250 (50 μm in diameter), manufactured by Sekisui Chemical Co., Ltd.) and the thermosetting epoxy resin mixture (Stract Bond HC-1850 manufactured by Mitsui Chemicals, Inc.) were kneaded to prepare an uncured body of the peripheral seal 12. Then, the uncured body of the peripheral seal 12 was applied onto the surface of the electrode 11a or 11b using a dispenser device. In this step, the coating pattern was drawn such that the two through-holes provided in one of the glasses were arranged in a region surrounded by the peripheral seal 12 after the glass bonding process described later. Then, the substrate on which the uncured body of the peripheral seal 12 had been applied was bonded with the other substrate such that the electrodes (11a, 11b) were facing each other. Then, the heat treatment was performed to cure the uncured body of the seal 12.

Then, the anodic EC compound (dihydrophenazine derivative) and the cathodic EC compound (viologen derivative) were dissolved in propylene carbonate with the concentrations shown in Table 2 to prepare four types of EC solutions. The “A/C” shown in Table 2 indicates a concentration ratio of the anodic EC compound to the cathodic EC compound contained in the EC layer.

TABLE 2

| Solutions | 1 | 2 | 3 | 4 |
|---|---|---|---|---|
| Concentration of Anodic EC | 2.33 | 2.59 | 2.80 | 2.97 |
| compound [mol/L] | | | | |
| Concentration of Cathodic EC | 2.33 | 2.07 | 1.86 | 1.69 |
| compound [mol/L] | | | | |
| A/C | 1 | 1.25 | 1.5 | 1.75 |
| Sum of Concentration of EC | 4.66 | 4.66 | 4.66 | 4.66 |
| compounds [mol/L] | | | | |

Then, the space defined by the facing electrodes (11a, 11b) and the peripheral seal 12 was filled with the EC solution through the above-described through-holes under a nitrogen atmosphere to obtain the EC layer 13. Then, an ultraviolet-curable acrylic resin (TB 3035 B manufactured by Three Bond) was applied to the periphery of the through holes, and then the through holes were shaped so as to be closed, and then cured by UV irradiation. Further, an ultraviolet curable epoxy resin (Photo Rec E-1220B manufactured by Sekisui Chemical Co., Ltd.) was applied to the same portion and cured by UV irradiation to obtain the EC element 1.

<<Evaluation of Color Unevenness>>

The EC element was arranged such that the element surface became horizontal. Then, as shown in FIG. 8A, an imaging apparatus 22 (Canon Eos kiss x5) was disposed above the element 1 and a surface illumination 21 (FUJICOLOR HR-2) was disposed below the element 1 such that the optical axis is perpendicular to the element surface. The EC element was driven by applying a voltage of 0.7 V between the anode and the cathode, and images were acquired for 24 hours at an interval of 30 minutes immediately after the EC element was driven. The acquired images were resized to 200 px×134 px. The R value, B value, and G value of all pixels included in the analysis region 25 of the acquired images were averaged to obtain reference RGB values. Further, the analysis region 25 was divided into 16 vertical and 16 horizontal rectangular regions, for a total of 256 rectangular regions, and the color difference ΔE₀₀ between the average RGB value and the reference RGB value in each region was calculated using the color difference expression based on the definition of CIEDE2000. The maximum value among the color differences ΔE00 obtained from each point as shown above was set as an absolute value of the color unevenness at each period of time, and the evaluation was performed using the absolute value of the color unevenness after 24 hours.

<<Evaluation Result>>

First, a voltage was applied to the EC element 1 filled with the solution to make the EC element in a colored state, and then the coloration spectra in the center portion of the element and the peripheral seal nearest region 13a were obtained. It was confirmed from the obtained spectral shape that the anodic EC compound was preferentially colored in the peripheral seal nearest region 13a. Further, the polarity of the voltage applied to the EC element was reversed, and then the coloration spectrum of the peripheral seal nearest region 13a was confirmed again, whereby the preferential coloring of the anodic EC compound was confirmed in the same manner as before the reversal. From the above results, it was confirmed that the peripheral seal of the embodiment was an anode preferential peripheral seal.

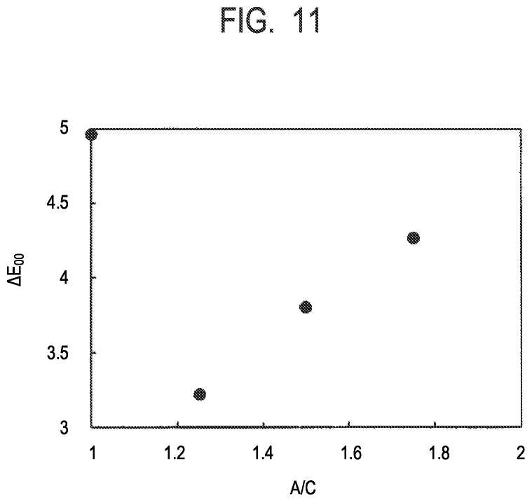

FIG. 11 shows a graph indicative of the correlation between the value of A/C, which is the concentration ratio of the anode EC compound to the cathode EC compound, and ΔE₀₀, which is an index of color unevenness. From FIG. 11, it can be confirmed that ΔE₀₀<4.5 is satisfied in the range of 1<A/C, and ΔE₀₀ is decreased compared with A/C=1. In particular, at A/C=1.25, the above-described condition of ΔE₀₀≤3.2 is satisfied, and it has been confirmed that color unevenness is highly suppressed.

From this embodiment, the following effects were confirmed.

(A) In an EC element which is a complementary type and in which the peripheral seal 12 is an anode preferential peripheral seal, color unevenness caused by the peripheral seal 12 can be highly suppressed by satisfying the following conditions.

(i) The concentration of the anodic EC compound in the EC layer 13 is larger than that of the cathodic EC compound in the EC layer 13.

(B) In an EC element which is a complementary type and in which the peripheral seal 12 is an anode preferential peripheral seal, the color unevenness caused by the peripheral seal 12 can be further highly suppressed by satisfying the following conditions in addition to the condition (i) of (A).

(ii) The A/C which is a ratio of the concentration of the anodic EC compound to the concentration of the cathodic EC compound in the EC layer 13 is larger than 1.2 and smaller than 1.8.

(C) The EC element which satisfies the above condition (i), preferably satisfies the conditions (i) and (ii) can highly suppress color unevenness caused by the peripheral seal 12 even at a concentration of the EC compound higher than 0.1 mol/L.

The same effect can also be confirmed in an EC element in which the peripheral seal 12 is a cathode-preferential peripheral seal.

According to the present invention, an EC element can be provided with suppressing the color unevenness caused by the peripheral seal.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

What is claimed is:

1. An electrochromic element comprising:
a first electrode;
a second electrode;
a peripheral seal disposed between the first electrode and the second electrode; and
an electrochromic layer disposed in a space defined by the first electrode, the second electrode, and the peripheral seal,
wherein the electrochromic layer includes an anodic electrochromic compound and a cathodic electrochromic compound,
wherein the peripheral seal is an anode preferential peripheral seal that takes preference of oxidation reaction of the anodic electrochromic compound near the peripheral seal, and
wherein the anodic electrochromic compound in the electrochromic layer has a concentration greater than a concentration of the cathodic electrochromic compound.

2. The electrochromic element according to claim 1, wherein the electrochromic layer has a concentration ratio of the anodic electrochromic compound to the cathodic electrochromic compound less than 2.

3. The electrochromic element according to claim 1, wherein the electrochromic layer has a concentration ratio of the anodic electrochromic compound to the cathodic electrochromic compound greater than 1.2 and less than 1.8.

4. An electrochromic element comprising:
a first electrode;
a second electrode;
a peripheral seal disposed between the first electrode and the second electrode; and
an electrochromic layer disposed in a space defined by the first electrode, the second electrode, and the peripheral seal,
wherein the electrochromic layer includes an anodic electrochromic compound and a cathodic electrochromic compound,
wherein the peripheral seal is a cathode preferential peripheral seal that takes preference of reduction reaction of the cathodic electrochromic compound near the peripheral seal, and
wherein the cathodic electrochromic compound in the electrochromic layer has a concentration greater than a concentration of the anodic electrochromic compound.

5. The electrochromic element according to claim 4, wherein the electrochromic layer has a concentration ratio of the cathodic electrochromic compound to the anodic electrochromic compound less than 2.

6. The electrochromic element according to claim 4, wherein the electrochromic layer has a concentration ratio of the cathodic electrochromic compound to the anodic electrochromic compound greater than 1.2 and less than 1.8.

7. The electrochromic element according to claim 1, wherein a sum of a concentration of the anodic electrochromic compound and a concentration of the cathodic electrochromic compound is equal to or greater than 0.1 mol/L or more in the electrochromic layer.

8. The electrochromic element according to claim 1, wherein a sum of a concentration of the anodic electrochromic compound and a concentration of the cathodic electrochromic compound is equal to or greater than 0.3 mol/L or more in the electrochromic layer.

9. The electrochromic element according to claim 1, wherein the electrochromic layer further comprises a solvent.

10. The electrochromic element according to claim 1, wherein the anodic electrochromic compound and the cathodic electrochromic compound are organic compounds.

11. An optical filter comprising:
the electrochromic element according to claim 1; and
an active element connected to the electrochromic element and driving the electrochromic element.

12. A lens unit comprising:
the optical filter according to claim 11; and
an imaging optical system having a plurality of lenses.

13. An imaging apparatus comprising:
the optical filter according to claim 11; and
a light receiving element for receiving light transmitted through the optical filter.

14. A window member comprising:
the electrochromic element according to claim 1; and
an active element connected to the electrochromic element.
